(19) United States
(12) Patent Application Publication
(10) Pub. No.: US 2009/0134100 A1
(43) Pub. Date: May 28, 2009

(54) ELONGATED FILM TAPE, METHOD OF USING SAME TO PREPARE A FILTER, FILTER AND METHOD OF USING FILTER

(75) Inventors: Dean Thomas DuPONT, Rockford, MI (US); Thomas HECK, Charlotte, NC (US); Jason Lester KIRK, Hermosa Beach, CA (US)

Correspondence Address: NORRIS, MCLAUGHLIN & MARCUS, PA, 875 THIRD AVENUE, 18TH FLOOR, NEW YORK, NY, 10022, US

(73) Assignee: TESA AG

(21) Appl. No.: 12/323,493

(22) Filed: Nov. 26, 2008

Related U.S. Application Data
(60) Provisional application No. 60/990,657, filed on Nov. 28, 2007.

(51) Int. Cl. B01D 27/06; C02F 1/00

(52) U.S. Cl. 210/767; 428/41.3; 156/187; 210/484

(57) ABSTRACT

An elongated film optionally having double-sided adhesive tapes adhered to both ends can be used to wrap a paper core and thereafter covered with a curable resin that is then cured to form a filter, especially a water filter, having a hardened canister about the paper core. The resulting filter is characterized by outstanding lack of visual imperfection.

### CROSS-REFERENCE TO RELATED APPLICATIONS

This application claims priority of U.S. Provisional Application No. 60/990,657, filed on Nov. 28, 2008.

### BACKGROUND OF THE INVENTION

1. Field of the Invention

The present invention relates to film tapes used in the preparation of filters, to filters and to methods of making and using filters.

2. Description of Related Art

Certain types of paper-based water filters have a core of paper wrapped with tape for processing stability and covered in resin for the final structural strength. The paper filter mass is assembled and put on a spindle to rotate while the tape layer is being applied. The resulting cocoon is then covered with the epoxy resin and cured to form the water filter canister.

The use of tapes with a release surface presents special problems with “wet-out” of the epoxy. When epoxy is spread over tape that has previously been adhered to a release surface, the epoxy will not completely cover the tape. This leads to voids called “fish eyes” that give the appearance of bubbles in the hardened canister shell, which is translated as an imperfection or defect.

Wet-out is a function of the surface energy of both the liquid and the solid surface. The liquid must have a lower surface energy to spread evenly on the solid. If the liquid does not have a lower surface energy than the solid, then the liquid cannot be dispersed over the surface of the solid and fish eyes result.

As it turns out, a tape with release coating has a very low surface energy. Indeed, this is the very mechanism that makes the release coating work. The adhesive will not spread across the release surface.

The epoxy resin, on the other hand, has a higher surface energy than the release coated side of the tape. As a result, the epoxy resin cannot be dispersed over the surface of the tape, leading to the formation of fish eyes.

Accordingly, there is a need in the art for a method of preparing a filter that avoids the problems associated with wet-out related to the use of tapes with a release surface.

### SUMMARY OF THE INVENTION

These and other objects were met with the present invention, which relates in a first embodiment to a film tape comprising:

a) an elongated film having first and second ends;

b) optionally a first double-sided adhesive tape adhered to the first end; and

c) optionally a second double-sided adhesive tape adhered to the second end.

The present invention relates in a second embodiment to a method of preparing a filter comprising a hardened canister surrounding a paper core, wherein the method comprises:

a) providing the inventive film tape;

b) adhering the inventive film tape to the paper core;

c) wrapping the film tape around the paper core;

d) covering the surface of the wrapped paper core with a curable resin; and

e) curing the resin to form the hardened canister surrounding the paper core.

The present invention relates in a third embodiment to a filter comprising:

a) a paper core;

b) the inventive film tape wrapped around the paper core; and

c) a cured resin forming a hardened canister surrounding the wrapped paper core.

The present invention relates in a fourth embodiment to a method of filtering a liquid comprising filtering the liquid through the inventive filter.

### BRIEF DESCRIPTION OF THE DRAWINGS

The invention will now be described in greater detail with reference to the drawings, wherein:

FIG. 1 is a schematic showing the construction of an exemplary tape according to the present invention, depicting the elongated film wound into a roll except for a leading portion, and a first double-sided adhesive tape adhered to the end of the leading portion of the elongated film and covered on the free adhesive side with a release liner, and a second double-sided adhesive tape adhered to the wound up second end of the elongated film; and

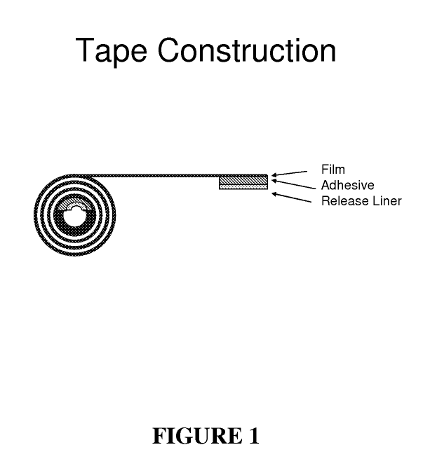

FIG. 2 is a schematic showing the tape shown in FIG. 1 being wrapped around a paper core.

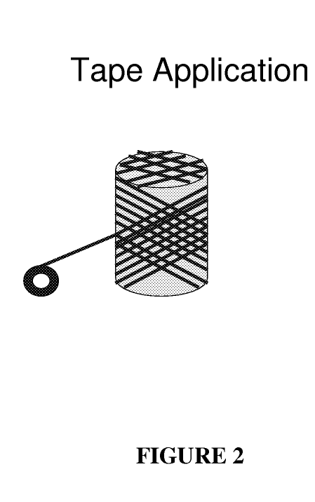

### DETAILED DESCRIPTION OF THE INVENTION

Materials which can be used as films in accordance with the present invention are monoaxially and biaxially oriented films, for example, based on polyesters or polyolefins, especially films based on oriented polyethylene, oriented polypropylene or oriented copolymers containing ethylene and/or polypropylene units. Particular preference is given to monoaxially oriented films based on polypropylene.

In theory, both single-layer and multiple-layer films are useful, although, primarily for cost reasons, a thickness as thin as possible is especially preferred, the limiting principle being that the film must be thick enough to withstand deformation during the epoxy application process. Preferably, the film has a total thickness of at least 20 μm, especially 30-200 μm, particularly 30-60 μm.

The film has a length sufficient to allow it to be wrapped multiple times around the paper core so as to cover the paper core at least partially or completely. Preferably, the film is at least two or three feet long or longer.

In one preferred embodiment, the elongated film has a first double-sided adhesive tape adhered to the first end thereof.

In another preferred embodiment, the elongated film has a first double-sided adhesive tape adhered to the first end thereof, and a second double-sided adhesive tape adhered to the second end thereof.

In yet another preferred embodiment, the elongated film does not have either a first double-sided adhesive tape adhered to the first end thereof, or a second double-sided adhesive tape adhered to the second end thereof.

Where the elongated film has first and/or second double-sided adhesive tapes adhered thereto, the first and second double-sided adhesive tapes are very short in length in comparison to the elongated tape, each being on the order of 1-3 inches in length preferably.

In an especially preferred embodiment, the tape consists of the elongated film, the first double-sided adhesive tape and the second double-sided adhesive tape, and the tape is non-adhesive over the entire length of the film except in the areas where the first and second double-sided adhesive tapes are adhered.

The inventive tape can be supplied to the end user in a ready-to-use form or in the form of a kit comprising the components necessary to construct the tape on-site. In the ready-to-use form, the inventive tape comprises a predetermined length of film optionally having the first and second double-sided adhesive tapes already adhered to the respective ends of the predetermined length of film, the predetermined length being a length calculated to be sufficient to wrap the film around a paper core of known diameter a predetermined number of times or to achieve a predetermined partial or complete coverage.

If the elongated film is not intended to comprise first and/or second double-sided adhesive tapes, the end user can, for example, hold one end of the film in place against the paper core, wind the film around the core until it overlaps the end being held, at which point that end can be released while the remainder of the film is wound around the core. When the full length of film has been wound around the core, the second end can be tucked into a previous winding, thereby securing the film around the core while the epoxy resin is applied.

If the elongated film comprises first and/or second double-sided adhesive tapes, these can be used to hold the first end and/or the second end of the film securely against the core while the epoxy resin is applied.

If the tape is supplied in the form of a kit, the kit preferably comprises a length of film and at least two double-sided adhesive tapes, which, especially, are covered on both sides with a release liner. When supplied with the kit, the end user adheres the first of the double-sided adhesive tapes to one end of the film, attaches the free adhesive side of that first double-sided adhesive tape to the paper core, wraps the paper core with the tape to the desired degree of coverage, then cuts the free end of the film and finally adheres the cut end to the paper core by means of the second double-sided adhesive tape, thereby completing the film application process.

Whether the inventive tape is supplied in the ready-to-use form or in the form of a kit, the tape, or the film in the case of a kit, can be wound into a roll.

If desired, the film can be pretreated prior to its incorporation into a ready-to-use form or a kit to enhance its properties in any desirable direction. For example, an especially preferred embodiment involves a film that has been subjected to a corona pretreatment in order to raise the surface energy of the film. The film is exposed to an electrical discharge or “corona,” and oxygen is broken down and bound to the free ends of molecules in the film. This results in a chemically active surface with a much higher surface energy level than the original film. In a preferred embodiment, the surface energy is controlled to above 35 dynes/cm, especially 38 dynes/cm or more.

The double-sided adhesive tape can be of any suitable construction, but for obvious reasons should be as thin as possible. Doubled-side adhesive tapes with or without backings can be used. Strips of adhesives without backings are especially preferred.

A wide range of adhesives can be used, the only significant limitations being that the adhesive must bond to the paper surface and the adhesive is not water-soluble. Suitable adhesives are preferably selected from water-insoluble pressure-sensitive adhesives, particularly water-insoluble acrylate adhesives, natural rubber-based adhesives or styrene-isobutyl-styrene (SIS) adhesives. In an especially preferred embodiment, the adhesive is a water-insoluble acrylate adhesive.

Once the elongated film tape is adhered to the paper core, whether by way of the first double-sided adhesive tape or not, a rotating spindle is preferably used to wrap the film around the paper core to a partial or complete coverage. The overlap of the wind keeps the film secured on the paper core. When used, the second double-sided adhesive strip at the end of the roll secures the wrap so the assembly can be transferred to the resin coating station. Alternatively, as noted above, a non-adhesive free end of the elongated film tape can be tucked inside a previous winding to secure the elongated film tape against the paper core.

A wide range of curable resins can be used, but preferably the selection is of resins that cure in air or under the application of heat. In a particularly preferred embodiment, the curable resin is an epoxy resin.

The filters prepared by the inventive method as described herein are characterized by outstanding properties, particularly the absence of visual imperfections or defects. They are especially useful for filtering liquids, particularly water, and can be used, for example, in water purification processes.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

What is claimed is:

1. A film tape comprising:
a) an elongated film having first and second ends;
b) optionally a first double-sided adhesive tape adhered to said first end; and
c) optionally a second double-sided adhesive tape adhered to said second end.

2. The film tape according to claim 1, which lacks said optional first and second double-sided adhesive tapes.

3. The film tape according to claim 1, wherein the elongated film is a film selected from the group consisting of oriented polyolefins or polyesters.

4. The film tape according to claim 1, wherein the elongated film is an oriented polyolefin film.

5. The film tape according to claim 4, wherein the elongated film is an oriented polyethylene film.

6. The film tape according to claim 4, wherein the elongated film is an oriented polypropylene film.

7. The film tape according to claim 1, which consists of the elongated film, the first double-sided adhesive tape and the second double-sided adhesive tape.

8. The film tape according to claim 7, which is wound into a roll.

9. The film tape according to claim 1, wherein the elongated film is corona-treated.

10. The film tape according to claim 1, which comprises at least one double-sided adhesive tape, wherein the double-sided adhesive tape comprises a backing.

11. The film tape according to claim 10, which further comprises a release material applied to a free adhesive side of said first double-sided adhesive tape and/or said second double-sided adhesive tape.

12. The film tape according to claim 1, which comprises at least one double-sided adhesive tape, wherein the double-sided adhesive tape does not comprise a backing.

13. The film tape adhesive according to claim 12, which further comprises a release material applied to a free adhesive side of said first double-sided adhesive tape and/or said second double-sided adhesive tape.

14. A method of preparing a filter comprising a hardened canister surrounding a paper core, said method comprising:
a) providing a film tape according to claim 1;
b) adhering the film tape to the paper core;
c) wrapping the film tape around the paper core;
d) covering the surface of the wrapped paper core with a curable resin; and
e) curing the resin to form the hardened canister surrounding the paper core.

15. The method according to claim 14, wherein the curable resin is a curable epoxy resin.

16. The method according to claim 15, wherein the curable epoxy resin is cured by drying.

17. A filter comprising:
a) a paper core;
b) a film tape according to claim 1 wrapped around the paper core; and
c) a cured resin forming a hardened canister surrounding the wrapped paper core.

18. The filter according to claim 17, wherein the cured resin is a cured epoxy resin.

19. A method of filtering a liquid comprising filtering the liquid through a filter according to claim 17.

20. The method according to claim 19, wherein the liquid is water.
